(19) United States
(12) Patent Application Publication
(10) Pub. No.: US 2019/0012204 A1
(43) Pub. Date: Jan. 10, 2019

(54) Reverse Tiling

(71) Applicant: QUALCOMM Incorporated, San Diego, CA (US)

(72) Inventors: Andrew TURNER, San Diego, CA (US); Bohuslav Rychlik, San Diego, CA (US); Zheng Liu, San Diego, CA (US)

(21) Appl. No.: 15/641,469

(22) Filed: Jul. 5, 2017

(51) Int. Cl. G06F 9/50; G06F 9/48

(52) U.S. Cl. CPC G06F 9/5016; G06F 9/4881

(57) ABSTRACT

Various aspects include methods and computing devices implementing methods for reverse tiling of work items. Various aspects may include receiving information relating to a kernel execution, receiving information relating to a work item created for a kernel execution, and applying a reverse tiling function to produce a reverse tiling work item identifier (ID) for the work item to implement a pattern of access of the memory device resources. In various aspects, the reverse tiling function may be a static preprogrammed reverse tiling function, a a dynamically generated reverse tiling function, or a reverse tiling function selected from a plurality of reverse tiling functions. In various aspects, applying the reverse tiling function to produce the reverse tiling work item identifier for the work item may occur in response to determining that the pattern of access of a memory device resources provides a benefit over a default pattern of access.

### BACKGROUND

Existing general purpose computing on a graphics processing unit (GPGPU) benchmarks show poor double data rate (DDR) random access memory (RAM) performance. Low DDR RAM efficiency is often due to DDR RAM access mechanics. Executing threads naively in order may cause imbalanced use of resources and unnecessary memory read/write congestion. When this occurs, performance is negatively affected, or increased hardware resources are needed, such as additional buffering and latency queues, to regain performance. These increased resources may be costly in terms of memory area usage and performance timing.

Various techniques have been used to improve DDR RAM access for GPGPU processes. One technique includes padding, which aligns waves of work items to the beginning of DDR RAM pages so that each wave only accesses a single page. This technique is helpful when multiple rows are processed concurrently in image based workloads, but is difficult to implement for GPGPU processes. Another technique includes graphics macrotiling for two dimensional groups of pixels, which controls the DDR RAM banks that are opened with respect to interleaving, but this technique does not apply for GPGPU processes.

### SUMMARY

Various disclosed aspects may include apparatuses and methods for implementing reverse tiling of work items on a computing device. Various aspects may include receiving information relating to a work item created for a kernel execution, and applying a reverse tiling function to produce a reverse tiling work item identifier (ID) for the work item to implement a pattern of access of memory device resources.

Some aspects may further include receiving information relating to the kernel execution, and generating the reverse tiling function based on the information relating to the kernel execution and the pattern of access of the memory device resources.

Some aspects may further include receiving information relating to the kernel execution, and selecting the reverse tiling function from a plurality of preprogrammed reverse tiling functions based on the information relating to the kernel execution and the pattern of access of the memory device resources.

In some aspects, receiving information relating to a work item created for the kernel execution may include receiving a work item ID for the work item, and applying a reverse tiling function to produce a reverse tiling work item ID for the work item may include modifying the work item ID.

In some aspects, applying a reverse tiling function to produce a reverse tiling work item ID for the work item may include generating a work item ID for the work item as the reverse tiling work item ID.

Some aspects may further include staggering access to a memory device resource at a beginning of an execution of a first work group containing the work item relative to a second work group executed in parallel to the first work group by applying the reverse tiling function to produce the reverse tiling work item ID for the work item and assigning the reverse tiling work item ID to the work item, and executing a plurality of work items in a sequential parallel order effecting the pattern of access of the memory device resources.

Some aspects may further include determining whether the reverse tiling work item ID is valid, and assigning the reverse tiling work item ID to the work item in response to determining that the reverse tiling work item ID is valid.

Some aspects may further include receiving information relating to the kernel execution, determining whether the pattern of access of memory device resources provides a benefit over a default pattern of access of the memory device resources for a kernel execution, in which applying a reverse tiling function to produce a reverse tiling work item identifier for the work item may include applying the reverse tiling function to produce the reverse tiling work item identifier for the work item in response to determining that the pattern of access of the memory device resources provides a benefit over the default pattern of access of the memory device resources.

Various aspects may further include a computing device having a memory device having memory device resources and a processor configured to perform operations of any of the methods summarized above. Various aspects may further include a computing device having means for performing functions of any of the methods summarized above. Various aspects may further include a non-transitory processor-readable medium on which are stored processor-executable instructions configured to cause a processor of a computing device to perform operations of any of the methods summarized above.

### BRIEF DESCRIPTION OF THE DRAWINGS

The accompanying drawings, which are incorporated herein and constitute part of this specification, illustrate example aspects of various aspects, and together with the general description given above and the detailed description given below, serve to explain the features of the claims.

FIG. 1 is a component block diagram illustrating a computing device suitable for implementing various aspects.

FIG. 2 is a component block diagram illustrating an example multicore processor suitable for implementing various aspects.

FIG. 3 is a component block diagram illustrating an example memory device and controller suitable for implementing various aspects.

FIG. 4 is a block diagram illustrating an example reverse tiling component suitable for implementing various aspects.

FIG. 5 is a block diagram illustrating an example of information used for controlling scheduling and execution of work items for implementing various aspects.

FIGS. 6A-6D are block diagrams illustrating examples of work item assignment to a memory device for execution of the work item for implementing various aspects.

FIG. 7 is a process flow diagram illustrating a method for implementing reverse tiling according to some aspects.

FIG. 8 is a process flow diagram illustrating a method for implementing reverse tiling according to some aspects.

FIG. 9 is a component block diagram illustrating an example mobile computing device suitable for use with the various aspects.

FIG. 10 is a component block diagram illustrating an example mobile computing device suitable for use with the various aspects.

FIG. 11 is a component block diagram illustrating an example server suitable for use with the various aspects.

### DETAILED DESCRIPTION

The various aspects will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various aspects may include methods, and computing devices implementing such methods for implementing reverse tiling for general purpose computing of very large numbers of work items mapped to many processing devices by applying tiling patterns to work items by modifying work item identifiers (IDs) to change the order of execution of waves and/or streaming processes, and/or staggering buffer allocations to start on different channels. The apparatus and methods of the various aspects may include modifying a work item ID by changing bits within the work item ID to change the order of execution of work items. Changes to the order in which work items are processed may result in the work items being executed using different addressed device resources, such as resources of a double data rate random access memory (DDR RAM), caches, and other addressed resources, at concurrent times. Addressed device resources may include multiple channels, buffer pages, cache lines, etc. The apparatus and methods of various aspects may modify the work item ID relating to a resource access function addresses for the work item, such as a load function, store function, etc., and involve changing the order of work items to change the addressed device resources that are used at various times as dictated by the related memory function address. Various aspects may use temporary shared addressed device device resources, such as cache lines and buffer pages, as completely and quickly as possible to avoid accessing again or tying up these resources. Various aspects may concurrently access in parallel as many bank addressed device device resources, such as scratch memory, cache, and DDR RAM banks, as needed to fulfill bandwidth needs (but possibly not more, which would utilize more temporary shared resources for longer). Various aspects are described herein in terms of a memory device for ease of explanation and brevity, the terms “memory device” and “addressed device” are used interchangeably, and the uses of a memory device are examples that are not intended to limit the descriptions or the scope of the claims.

The terms “computing device” and “mobile computing device” are used interchangeably herein to refer to any one or all of cellular telephones, smartphones, personal or mobile multi-media players, personal data assistants (PDA's), laptop computers, tablet computers, convertible laptops/tablets (2-in-1 computers), smartbooks, ultrabooks, netbooks, palm-top computers, wireless electronic mail receivers, multimedia Internet enabled cellular telephones, mobile gaming consoles, wireless gaming controllers, and similar personal electronic devices that include a memory, and a programmable processor. The term “computing device” may further refer to stationary computing devices including personal computers, desktop computers, all-in-one computers, workstations, super computers, mainframe computers, embedded computers, servers, home theater computers, and game consoles.

A work item to be processed by a processing device may be assigned a work item ID. The work item ID may specify a work group number and a wave number, or streaming process, to which the work item belongs. Waves of work items are generally a hardware implemented and the waves can change based on implementation of the processing device. Work items may be scheduled for execution in order of their work group numbers and wave numbers. Work items are typically scheduled sequentially within the wave with which they are associated. The work item ID may be related to any number of memory function addresses for a kernel to use for executing the work item. A kernel may include any routine for high throughput execution of work items by a processing device, such as a hardware accelerator. Each memory function address may dictate the channel that may be used to access a bank of the memory device and the buffer page of the memory device to access in the bank. The channel may be controlled by dedicated bits of the memory function address, such as a channel interleave bit. Similarly, the buffer page may be controlled by dedicated bits of the memory function address, such as a page bit. Various aspects are described herein in terms of a one-to-one relationship between a work item and a single memory function address for ease of explanation and brevity; however, the various aspects similarly apply to one-to-many relationships between a work item and multiple memory function address. Thus, the uses of a one-to-one relationship between a work item and a single memory function address are examples that are not intended to limit the descriptions or the scope of the claims.

The channel interleave bits of various memory function addresses may designate a same channel for executing the work items of a wave to which some of the work items belong and a same or different channel for executing the work items of another wave to which others of the work items belong. In other words, each work item of a wave may be executed using the same channel designated by the same channel interleave bit value in the memory function address for each work item of the wave, and channel interleave bit values may be the same or vary between waves. The page bits of various memory function addresses may designate a same buffer page for executing the work items of a work group, which may include multiple waves, and a same or different buffer page for executing the work items of another work group. In other words, each work item of a work group may be executed using the same buffer page designated by the same page bit value in the memory function address for each work item of the work group, and page bit values may be the same or vary between work groups.

Sequentially executing work items based on sequential assignment of work item IDs may result in memory device resource access patterns in which multiple work items of different work groups and waves executing in parallel concurrently accessing different conflicting temporary shared memory device resources in too few banks causes thrashing of the shared memory device resource. Sequential execution of work items in such a manner may cause imbalanced use of resources and unnecessary congestion, and result in negatively affecting processing performance of the computing device, and/or require increased resources of the computing device, such as buffering and latency queues, to achieve processing performance levels.

To alleviate the issues of sequential work item execution, the order of work item execution may be changed such that a newly ordered memory access pattern increases balanced use of resources and/or reduces congestion. Reordering of the work item execution may be accomplished by changing the work item ID of each work item via some function so that a work item with a work item ID f(x) actually executes code as if it were work item x. Various mechanisms and functions for making changes to the work item ID may enable more efficient memory/component access order, which may improve processing performance for work items and/or reduce resource consumption for implementing the same work items.

In various aspects, work item IDs may be modified to change bits of the work item IDs, such as a wave number portion and/or a work group number portion of the work item IDs, to change the order of execution of work items. This bit manipulation of the bit values of the work item IDs may change the order of execution of work items changing access patterns to memory device resources controlled by the memory function addresses for work items executing in parallel. The patterns may dictate concurrent access to different banks of a memory device by different channels and/or concurrent access to different buffer pages of the memory device. Bit manipulation of the bit values may be implemented to control the order in which waves of work items are executed based on the wave number for the work items and the order in which channels are used to access memory device banks. For example, bit manipulation may be used to change the order of a pair of concurrent waves that are associated with memory function addresses that include the same channel interleave bit value by changing the wave number of the work items of at least one of the waves so that they are no longer executed concurrently with the work items of another of the waves. The bit manipulation of the wave numbers may make multiple work items into concurrent work items with memory function addresses that use different channels to access different banks.

In various aspects, bit manipulation of the bit values of the work item IDs (including the wave number and/or work group number) may be implemented to control the order in which work groups of work items are executed based on the work group number for the work items and the order in which buffer pages are accessed. For example, bit manipulation may be used to change the order of a pair of concurrent workgroups that are associated with memory function addresses that include the same page bit value by changing the work group number of a first work group so that it is no longer concurrent with a second work group. A third work group that is associated with a memory function address that includes a different page bit value from the page bit value of the first and second work groups may be made concurrent with the first work group by changing the work group number of the third work group. The bit manipulation of the work group numbers may make the first work group and the third work group into concurrent work groups with memory function addresses that access different page buffers.

In various aspects, multiple bit manipulations may be used in combination to change the order of execution of work items based on both wave number and work group number. Bit manipulation in the work item IDs may include any bit operation, such as swapping, shifting, arithmetic operations, and logical operations. Bit manipulation in the work item IDs may be implemented in hardware used to assign work item IDs or in software to change hardware assigned work item IDs.

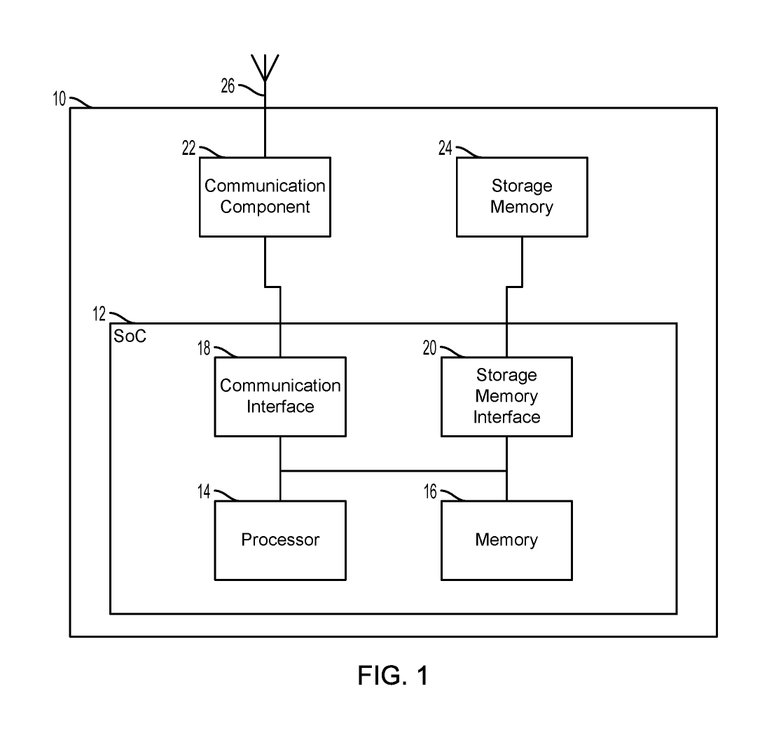

FIG. 1 illustrates a system including a computing device 10 suitable for use with the various aspects. The computing device 10 may include a system-on-chip (SoC) 12 with a processor 14, a memory 16, a communication interface 18, and a storage memory interface 20. The computing device 10 may further include a communication component 22, such as a wired or wireless modem, a storage memory 24, and an antenna 26 for establishing a wireless communication link. The processor 14 may include any of a variety of processing devices, for example a number of processor cores.

The term “system-on-chip” (SoC) is used herein to refer to a set of interconnected electronic circuits typically, but not exclusively, including a processing device, a memory, and a communication interface. A processing device may include a variety of different types of processors 14 and processor cores, such as a general purpose processor, a central processing unit (CPU), a digital signal processor (DSP), a graphics processing unit (GPU), an accelerated processing unit (APU), a subsystem processor of specific components of the computing device, such as an image processor for a camera subsystem or a display processor for a display, an auxiliary processor, a single-core processor, and a multicore processor. A processing device may further embody other hardware and hardware combinations, such as a field programmable gate array (FPGA), an application-specific integrated circuit (ASIC), other programmable logic device, discrete gate logic, transistor logic, performance monitoring hardware, watchdog hardware, and time references. Integrated circuits may be configured such that the components of the integrated circuit reside on a single piece of semiconductor material, such as silicon.

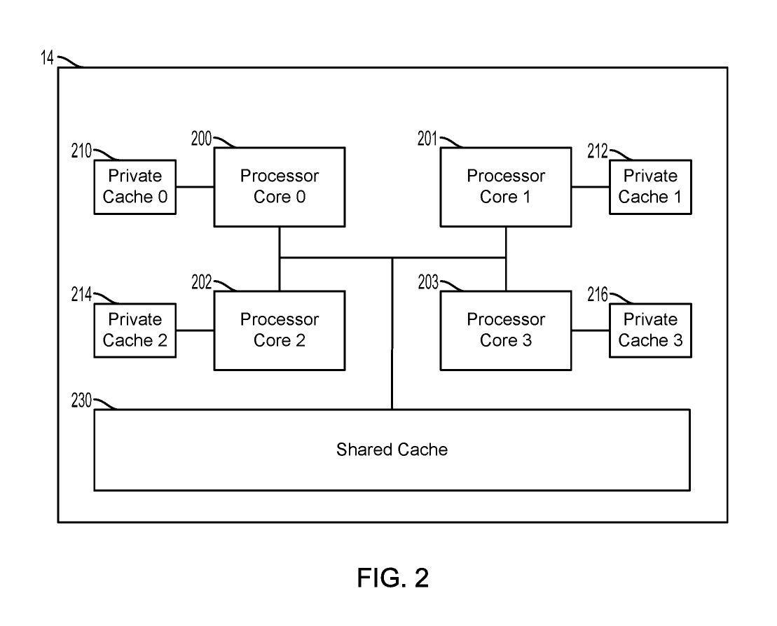

An SoC 12 may include one or more processors 14. The computing device 10 may include more than one SoC 12, thereby increasing the number of processors 14 and processor cores. The computing device 10 may also include processors 14 that are not associated with an SoC 12. Individual processors 14 may be multicore processors as described below with reference to FIG. 2. The processors 14 may each be configured for specific purposes that may be the same as or different from other processors 14 of the computing device 10. One or more of the processors 14 and processor cores of the same or different configurations may be grouped together. A group of processors 14 or processor cores may be referred to as a multi-processor cluster.

The memory 16 of the SoC 12 may be a volatile or non-volatile memory configured for storing data and processor-executable code for access by the processor 14. The computing device 10 and/or SoC 12 may include one or more memories 16 configured for various purposes. One or more memories 16 may include volatile memories such as random access memory (RAM) or main memory, or cache memory. These memories 16 may be configured to temporarily hold a limited amount of data received from a data sensor or subsystem, data and/or processor-executable code instructions that are requested from non-volatile memory, loaded to the memories 16 from non-volatile memory in anticipation of future access based on a variety of factors, and/or intermediary processing data and/or processor-executable code instructions produced by the processor 14 and temporarily stored for future quick access without being stored in non-volatile memory.

The memory 16 may be configured to store data and processor-executable code, at least temporarily, that is loaded to the memory 16 from another memory device, such as another memory 16 or storage memory 24, for access by one or more of the processors 14. The data or processor-executable code loaded to the memory 16 may be loaded in response to execution of a function by the processor 14. Loading the data or processor-executable code to the memory 16 in response to execution of a function may result from a memory access request to the memory 16 that is unsuccessful, or a “miss,” because the requested data or processor-executable code is not located in the memory 16. In response to a miss, a memory access request to another memory 16 or storage memory 24 may be made to load the requested data or processor-executable code from the other memory 16 or storage memory 24 to the memory device 16. Loading the data or processor-executable code to the memory 16 in response to execution of a function may result from a memory access request to another memory 16 or storage memory 24, and the data or processor-executable code may be loaded to the memory 16 for later access.

The storage memory interface 20 and the storage memory 24 may work in unison to allow the computing device 10 to store data and processor-executable code on a non-volatile storage medium. The storage memory 24 may be configured much like an aspect of the memory 16 in which the storage memory 24 may store the data or processor-executable code for access by one or more of the processors 14. The storage memory 24, being non-volatile, may retain the information after the power of the computing device 10 has been shut off. When the power is turned back on and the computing device 10 reboots, the information stored on the storage memory 24 may be available to the computing device 10. The storage memory interface 20 may control access to the storage memory 24 and allow the processor 14 to read data from and write data to the storage memory 24.

Some or all of the components of the computing device 10 may be arranged differently and/or combined while still serving the functions of the various aspects. The computing device 10 may not be limited to one of each of the components, and multiple instances of each component may be included in various configurations of the computing device 10.

FIG. 2 illustrates a multicore processor suitable for implementing an aspect. The multicore processor 14 may include multiple processor types, including, for example, a CPU and various hardware accelerators, including for example, a GPU, a DSP, an APU, subsystem processor, etc. The multicore processor 14 may also include a custom hardware accelerator, which may include custom processing hardware and/or general purpose hardware configured to implement a specialized set of functions.

The multicore processor may have a plurality of homogeneous or heterogeneous processor cores 200, 201, 202, 203. A homogeneous multicore processor may include a plurality of homogeneous processor cores. The processor cores 200, 201, 202, 203 may be homogeneous in that, the processor cores 200, 201, 202, 203 of the multicore processor 14 may be configured for the same purpose and have the same or similar performance characteristics. For example, the multicore processor 14 may be a general purpose processor, and the processor cores 200, 201, 202, 203 may be homogeneous general purpose processor cores. The multicore processor 14 may be a GPU or a DSP, and the processor cores 200, 201, 202, 203 may be homogeneous graphics processor cores or digital signal processor cores, respectively. The multicore processor 14 may be a custom hardware accelerator with homogeneous processor cores 200, 201, 202, 203.

A heterogeneous multicore processor may include a plurality of heterogeneous processor cores. The processor cores 200, 201, 202, 203 may be heterogeneous in that the processor cores 200, 201, 202, 203 of the multicore processor 14 may be configured for different purposes and/or have different performance characteristics. The heterogeneity of such heterogeneous processor cores may include different instruction set architecture, pipelines, operating frequencies, etc. An example of such heterogeneous processor cores may include what are known as “big.LITTLE” architectures in which slower, low-power processor cores may be coupled with more powerful and power-hungry processor cores. In similar aspects, an SoC (for example, SoC 12 of FIG. 1) may include any number of homogeneous or heterogeneous multicore processors 14. In various aspects, not all off the processor cores 200, 201, 202, 203 need to be heterogeneous processor cores, as a heterogeneous multicore processor may include any combination of processor cores 200, 201, 202, 203 including at least one heterogeneous processor core.

Each of the processor cores 200, 201, 202, 203 of a multicore processor 14 may be designated a private cache 210, 212, 214, 216 that may be dedicated for read and/or write access by a designated processor core 200, 201, 202, 203. The private cache 210, 212, 214, 216 may store data and/or instructions, and make the stored data and/or instructions available to the processor cores 200, 201, 202, 203, to which the private cache 210, 212, 214, 216 is dedicated, for use in execution by the processor cores 200, 201, 202, 203. The private cache 210, 212, 214, 216 may include volatile memory as described herein with reference to memory 16 of FIG. 1.

The multicore processor 14 may further include a shared cache 230 that may be configured to read and/or write access by the processor cores 200, 201, 202, 203. The private cache 210, 212, 214, 216 may store data and/or instructions, and make the stored data and/or instructions available to the processor cores 200, 201, 202, 203, for use in execution by the processor cores 200, 201, 202, 203. The shared cache 230 may also function as a buffer for data and/or instructions input to and/or output from the multicore processor 14. The shared cache 230 may include volatile memory as described herein with reference to memory 16 of FIG. 1.

In the example illustrated in FIG. 2, the multicore processor 14 includes four processor cores 200, 201, 202, 203 (i.e., processor core 0, processor core 1, processor core 2, and processor core 3). In the example, each processor core 200, 201, 202, 203 is designated a respective private cache 210, 212, 214, 216 (i.e., processor core 0 and private cache 0, processor core 1 and private cache 1, processor core 2 and private cache 2, and processor core 3 and private cache 3). For ease of explanation, the examples herein may refer to the four processor cores 200, 201, 202, 203 and the four private caches 210, 212, 214, 216 illustrated in FIG. 2. However, the four processor cores 200, 201, 202, 203 and the four private caches 210, 212, 214, 216 illustrated in FIG. 2 and described herein are merely provided as an example and in no way are meant to limit the various aspects to a four-core processor system with four designated private caches. The computing device 10, the SoC 12, or the multicore processor 14 may individually or in combination include fewer or more than the four processor cores 200, 201, 202, 203 and private caches 210, 212, 214, 216 illustrated and described herein. For ease of reference, the terms “hardware accelerator,” “custom hardware accelerator,” “multicore processor,” “processor,” and “processor core” may be used interchangeably herein.

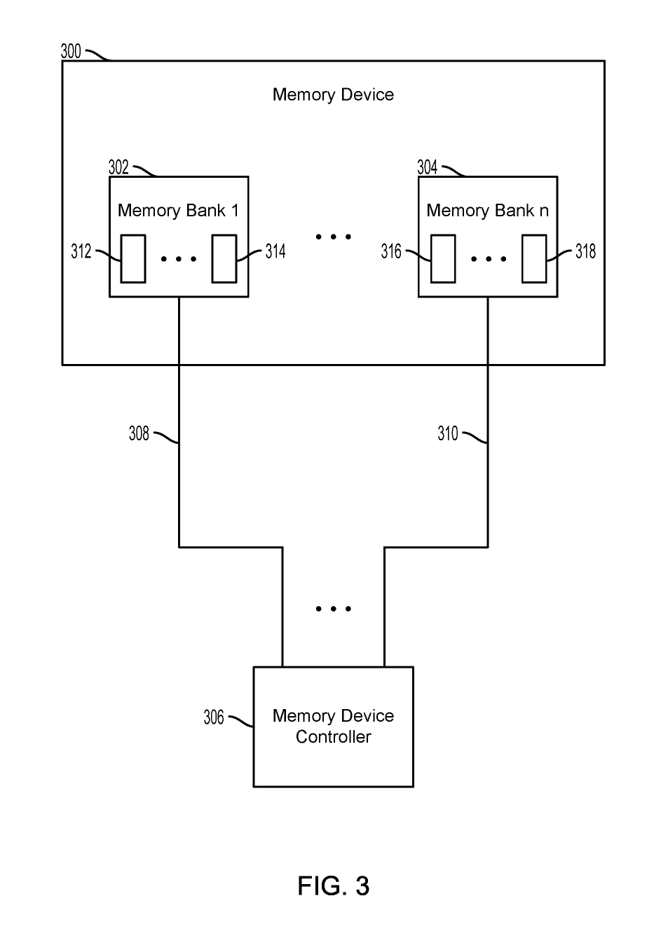

FIG. 3 illustrates a memory device and controller for implementing an aspect. With reference to FIGS. 1-3, the computing device (e.g., computing device 10 in FIG. 1) may include a multi-channel memory device 300 (e.g., memory 16, 24 in FIG. 1, private cache 210, 212, 214, 216 and shared cache 230 in FIG. 2). The multi-channel memory device 300 may include any number of memory banks 302, 304 that may be accessed concurrently by a memory device controller 306 configured to control access to and implement access and/or maintenance operations for the multi-channel memory device 300. The various memory banks 302, 304 may be associated with a channel 308, 310 for access to the memory banks 302, 304 by the memory device controller 306. In various aspects, each channel 308, 310 may be dedicated for access to an associated memory bank 302, 304. The memory device controller 306 may access a memory bank 302, 304 by an associated channel 308, 310 to implement memory access requests from a processor (e.g., processor 14 in FIGS. 1 and 2). The memory banks 302, 304 of the multi-channel memory device 300 may be accessed concurrently by the memory device controller 306 via different channels 308, 310. Further, a memory bank 302, 304 may each include memory spaces divided into any number of buffer pages 312, 314, 316, 318. The memory device controller 306 may concurrently access buffer pages 312, 314, 316, 318 of different memory banks 302, 304 via different channels 308, 310.

Code and/or data for executing a work item may be stored on a memory bank 302, 304 and a buffer page 312, 314, 316, 318 specified by a memory function address for the work item. To execute a work item by a processor, the processor may request access to the memory bank 302, 304 and a buffer page 312, 314, 316, 318 for storing the code and/or data for executing the work item. The access request from the processor may be received by the memory device controller 306, which may implement the memory access request to the memory bank 302, 304 and a buffer page 312, 314, 316, 318 storing the code and/or data for executing the work item.

The descriptions herein of computing devices (e.g., computing device 10 in FIG. 1) and associated components illustrated in FIGS. 1-3 are only meant to be non-limiting examples suitable for implementing various aspects. Several of the components of the illustrated example computing devices may be variably configured, combined, and separated. Several of the components may be included in greater or fewer numbers, and may be located and connected differently within an SoC (e.g., SoC 12 in FIG. 1) or separate from the SoC. Similarly, numerous other components, such as other memories, processors, subsystems, interfaces, and controllers, may be included in the computing device.

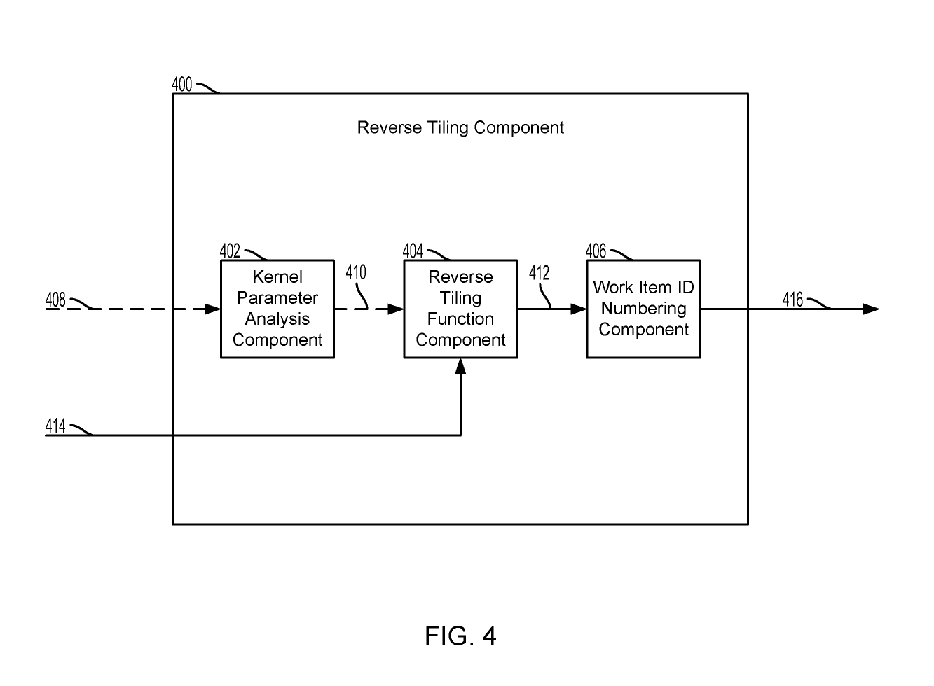

FIG. 4 illustrates an example of a reverse tiling component 400 according to some aspects. In various aspects, a reverse tiling component 400 may be implemented in software executed by a processor (e.g., processor 14 in FIGS. 1 and 2), the implemented in dedicated hardware configured to implement reverse tiling, and/or implemented in a combination of processor-executed software and dedicated hardware. The reverse tiling component 400 may include various other components implemented as hardware and/or software in the same manner as the reverse tiling component 400. Various components of the reverse tiling component 400 may include a kernel parameter analysis component 402, a reverse tiling function component 404, and a work item ID numbering component 406.

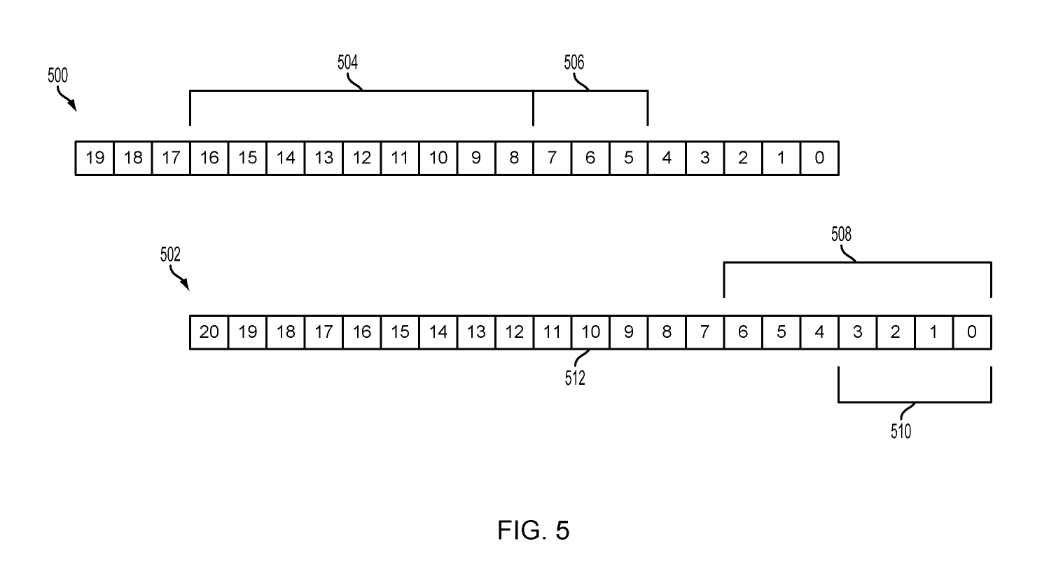

The reverse tiling component 400 may be configured to assign work item IDs to work items in a manner so that the work items are executed in an order that may be in accordance with a pattern of use of memory device resources (e.g., memory banks 302, 304 and buffer pages 312, 314, 316, 318 in FIG. 3) that differs from a default pattern of use of the memory device resources. For example, work items may be executed in a sequential order according to a work item ID associated with each work item within the waves with which the work items are associated. As discussed further herein, each work item may be associated with any number of memory function addresses specifying the memory device resources for use in executing the work item. In various aspects, a memory function addresses of multiple work items executing in parallel may specify the same and/or overlapping memory device resources for use in executing the work items. Sequential execution of work items according to their work item IDs may result in a default pattern of use of the memory device resources resulting in channel imbalance by attempting to concurrently access the same memory bank by multiple work items, and concurrently opening less than a possible number of buffer pages. An example of this default pattern of use of the memory device resources is further described with reference to FIG. 5A. Examples of patterns of use of memory device resources different from the default pattern of use of the memory device resources are described with reference to FIGS. 5B-5D.

Various configurations of the reverse tiling component 400 may be used to assign work item IDs to work items to realize patterns of use of memory device resources that are different from the default pattern of use of the memory device resources. In various aspects, reverse tiling functions may be used to assign the work item IDs. In various aspects, reverse tiling functions may assign the work item IDs where work item IDs are yet to be assigned and/or may assign the work item IDs by modifying existing work item IDs, such as through bit manipulation. Multiple different reverse titling functions may be implemented to assign work item IDs.

The reverse tiling functions for assigning work item IDs may be base on a few assumptions. For example, reverse tiling functions for assigning work item IDs may be base on a presumption that consecutive work item IDs access consecutive memory locations. As another example, reverse tiling functions for assigning work item IDs may be configured to keep enough consecutive work items to use full lines in the memory (e.g., memory 16, 24 or FIGS. 1 and 2, private cache 210, 212, 214, 216 and shared cache 230 in FIG. 2, and memory device 300 in FIG. 3). As a further example, reverse tiling functions for assigning work item IDs may be configure to switch between parallel memory resources in a manner that improves traffic flow (at a faster or a preferred rate of switching than a default pattern of use of the memory device resources) and/or to take advantage of data locality in the memory (slower switching than a default pattern of use of the memory device resources). As a further example, reverse tiling functions for assigning work item IDs may be based in terms of waves of work items and/or in terms of work groups of waves.

The reverse tiling function may depend on a kernel load size to determine that size of an accessed portion of the memory for execution of each work item for a kernel. The kernel load size may be used to determine that number of work items in a wave and/or the number of work items and/or waves in a work group. Using this information, the reverse tiling function may assign work item IDs to work items so that the pattern of use of the memory device resources may change based on completion of a wave and/or a work group.

In various aspects, the reverse tiling function for assigning work item IDs to work items may be static and preprogrammed based on prior analysis of common kernel executions of a computing device. The reverse tiling function may be configured to provide certain benefits based on the expected common kernel execution behavior, and may have varying levels of effectiveness for kernels that differ in primary load size or access order from the expected common kernel execution behavior. Regardless, a static reverse tiling function for assigning work item IDs to work items may not change for the kernels that differ in kernel load size from the common kernel executions.

Referring to FIG. 4, for static reverse tiling functions, the reverse tiling component 400 may receive a work item 414 (e.g., from a processor) in the reverse tiling function component 404. In various aspects, receiving the work item 414 may include receiving information relating to the work item 414, such as an indication of the work item created as a unit for execution of a kernel, a memory function address for the work item, and/or a previously assigned work item ID. In response to receiving a work item 414, the reverse tiling function component may provide the reverse tiling function for assigning work item IDs to work items 412 and/or information relating to the work item 414 to the work item ID numbering component 406. A new and/or modified work item ID may be calculated by the work item ID numbering component 406 using the reverse tiling function and/or information relating to the work item 414, and the work item ID numbering component 406 may assign the calculated work item ID to the work item. The reverse tiling component 400 may output the calculated work item ID 416 to a component of the computing device, such as a scheduler, a queue, or a register (not shown), so that the work item may be executed according to its calculated work item ID.

In various aspects, the reverse tiling function for assigning work item IDs to work items may be dynamic and determined for execution of a kernel by the computing device. The reverse tiling function may be selected or configured to provide certain benefits based on the kernel parameters for a kernel executed by the computing device. The reverse tiling component 400 may receive kernel parameters 408 (e.g., from a processor) in the kernel parameter analysis component 402 and the work item 414 in the reverse tiling function component 404. The kernel parameters 408 may include an identification of the executing kernel of which the work item is a unit for execution of the kernel and/or a kernel load size for the kernel. In various aspects, the kernel load size may include the most prominent memory load instruction in the kernel. Ways to determine the kernel load size may include static analysis, such as finding the most common load/store size amongst load/stores inside the innermost loops of a program execution. Other options may include kernel profiling with a small sample or simulator. Similar to the static reverse tiling function implementation, receiving the work item 414 may include receiving information relating to the work item 414, such as an indication of the work item created as a unit for execution of a kernel, a memory function address for the work item, and/or a previously assigned work item ID.

In response to receiving receive kernel parameters 408, the kernel parameter analysis component 402 may determine whether applying a reverse tiling function resulting in certain patterns of use of the memory device resources may be beneficial over the default pattern of use of the memory device resources and/or other certain patterns of use of the memory device resources. The kernel parameter analysis component 402 may select a pattern of use of the memory device resources for the kernel that may provide a certain benefit and/or certain combination of benefits, which may be preprogrammed for the specific kernel and/or may be general benefits for execution of kernels on the computing device.

The kernel parameter analysis component 402 may send information of the selected pattern of use of the memory device resources 410 to the reverse tiling function component 404. Using the information of the selected pattern of use of the memory device resources 410 and/or the information relating to the work item 414, the reverse tiling function component 404 may select and/or generate a reverse tiling function for assigning work item IDs to work items to implement the selected pattern of use of the memory device resources.

The reverse tiling function component 400 may provide the reverse tiling function for assigning work item IDs to work items 412 and/or information relating to the work item 414 to the work item ID numbering component 406. A new and/or modified work item ID may be calculated by the work item ID numbering component 406 using the reverse tiling function and/or information relating to the work item 414, and the work item ID numbering component 406 may assign the calculated work item ID to the work item. The reverse tiling component 400 may output the calculated work item IDs 416 to a component of the computing device, such as a scheduler, a queue, or a register (not shown), so that each work item may be executed according to its calculated work item ID.

In various aspects of either static or dynamic use of reverse tiling functions for assigning work item IDs to work items, the reverse tiling functions may be configured to stagger memory device resource access at the beginning of parallel execution of work groups. For example, two work groups executing in parallel may begin with execution of work items of a wave that access at least one different memory device resource, such as two different channels and/or two different buffer pages. For example, work groups with work items that access the same buffer page may stagger work items to begin execution accessing different channels. In another example, work groups with work items that access different buffer pages may be executed in parallel because the buffer page accesses are staggered to begin execution of the work items. In another example, access of buffer pages and channels may be staggered at the beginning of execution of multiple work items in parallel.

Various reverse tiling functions may be preprogrammed, selected, and/or generated by the reverse tiling function component 404 to be used to achieve different patterns of use of the memory device resources. In various aspects, multiple bit manipulations can be used in combination to change the order of execution of work items based on wave number and/or work group number in the work item ID. Bit manipulation in the work item IDs may include or involve any bit operation, such as masking, swapping, shifting, arithmetic operations, and logical operations. Examples of bit manipulation operations that may be used in various aspects include: an XOR operation of bits in the work item ID; swapping of bits in the work item ID; a combination of an XOR operation of a first set of bits in the work item ID and swapping of a second set of bits in the work item ID; a combination of moving a bit in the work item ID, shifting a first set of bits in the direction of the original location of the moved bit, and an XOR operation of one of the previously operated on bits with another bit of the work item ID; generic bit permutation of a bit in the work item ID; a one to one mapping of bits in the work item ID; and any combination of multiple same bit operations and/or different bit operations. The foregoing examples of bit manipulation for the reverse tiling function is a non-exhaustive list of examples, and any arithmetic, logical, and/or mapping operations may be used to modify bits of a work item ID to achieve different patterns of use of the memory device resources from the order of execution of the work items based on their work item IDs. Further, the reverse tiling functions are not limited to the work item ID for input data. Other stateful information could be used as sources for input into the reverse tiling functions.

Various aspects are described with reference to FIGS. 5-8 refer to example hardware components described with reference to FIGS. 1-4. The references to combinations of hardware components are in no way intended to be limiting to the number or type processors, hardware accelerators, memory devices, memory device controllers, reverse tiling components, kernel parameter analysis components, reverse tiling function components, and work item ID numbering components that may be included as hardware components for implementing the various aspects described herein.

FIG. 5 illustrates examples of information used for controlling scheduling and execution of work items for implementing various aspects. A work item ID 500 and a memory function address 502 may be used for controlling scheduling and execution of work items. As noted herein, a work item may be associated with any number of memory function addresses 502. The work item ID 500 may be used to control the scheduling of execution of an associated work item by being numbered relative to other work item IDs 500 in a manner that a scheduling algorithm, such as a sequential (without reverse tiling) or non-sequential (with reverse tiling) work item ID scheduling algorithm, may schedule execution of the associated work item relative to other work items associated with the other work item IDs 500. The memory function address 502 may control use of the memory device resources by indicating memory device resources to use for execution of an associated work item. Together, work item IDs 500 and a memory function addresses 502 for multiple work items may control a pattern of use of the memory device resources by controlling when work items that use certain memory device resources are executed.

A work item ID 500 may include any number of bits, for example bits 0-19, and different sets of these bits 504, 506 may identify different characteristics of the work item associated with the work item ID 500. In various aspects, a set of bits 504 may specify a work group number of the kernel execution to which the work item associated with the work item ID 500 belongs. A work group may be a unit of execution of the kernel including any number of waves and work items. In various aspects, a set of bits 506 may specify a wave number of the kernel execution to which the work item associated with the work item ID 500 belongs. A wave may be a unit of execution of the kernel including any number of work items. In various aspects the set of bits 504 may alternatively specify a streaming process of the kernel execution to which the work item associated with the work item ID 500 belongs. A streaming process may be a unit of execution of the kernel including any number of work items.

A memory function address 502 may include any number of bits, for example bits 0-20, and different sets of these bits 508, 510 and or individual bits 512 may identify different characteristics of the work item associated with the memory function address 502. A set of bits 508 may correspond to a memory access size for the work item associated with the memory function address 502. The access size of the work item may be a size of a memory space in a memory device (e.g., memory 16, 24 or FIGS. 1 and 2, private cache 210, 212, 214, 216 and shared cache 230 in FIG. 2, and memory device 300 in FIG. 3) in which code and/or data for the work item is stored. The access size of the work item may be used as the kernel load size by the reverse tiling component (e.g., reverse tiling component 400 in FIG. 4). A set of bits 510 may correspond with a size of a line of memory in the memory device. In various aspects, a bit 512 may correspond to an indicator for accessing a memory device resource, such as a memory bank (e.g., memory bank 302, 304 in FIG. 3), a channel (e.g., channel 308, 310), and/or a buffer page (e.g., buffer page 312, 314, 316, 318 in FIG. 3) of a memory device. Different bits 512 may correspond to indicators for accessing different memory device resources.

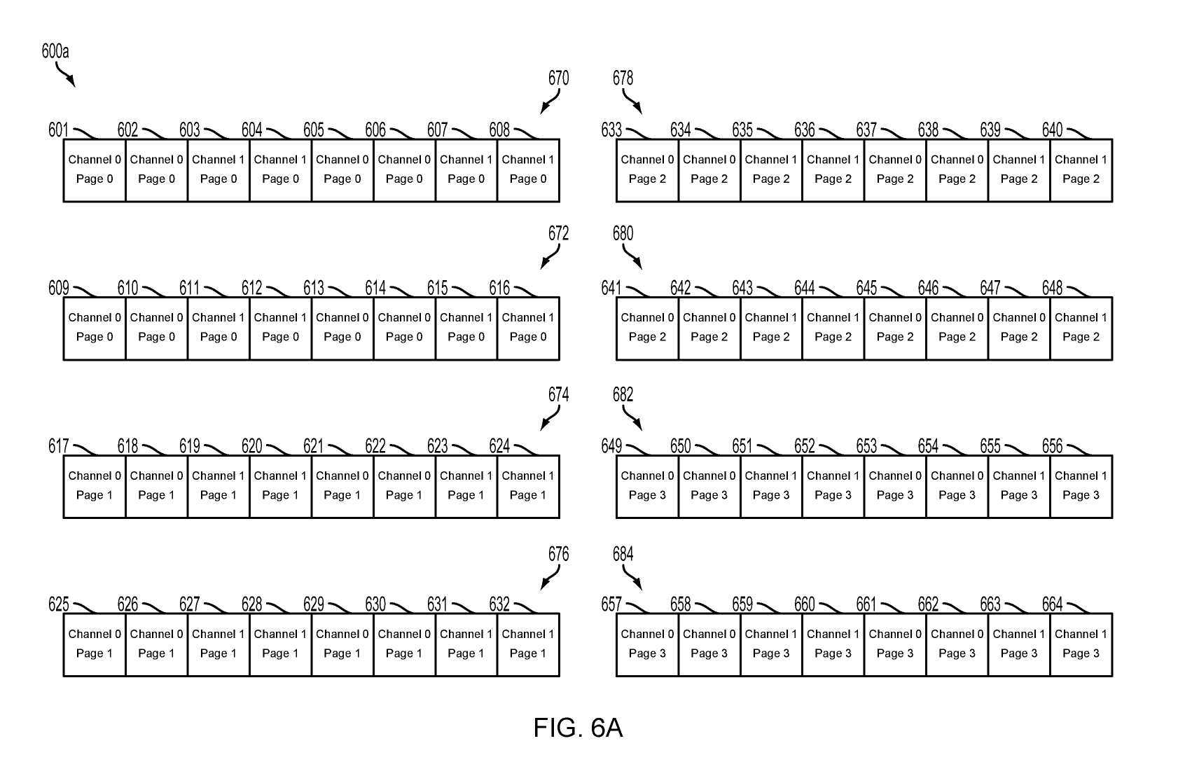

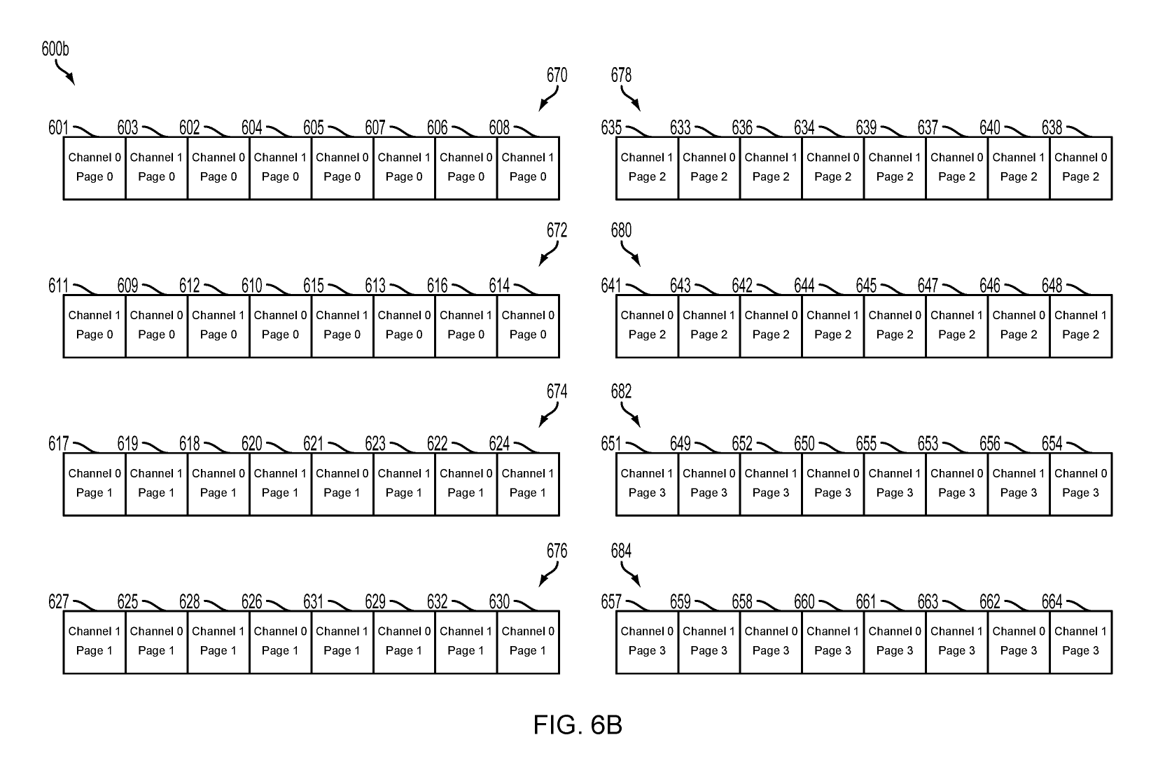

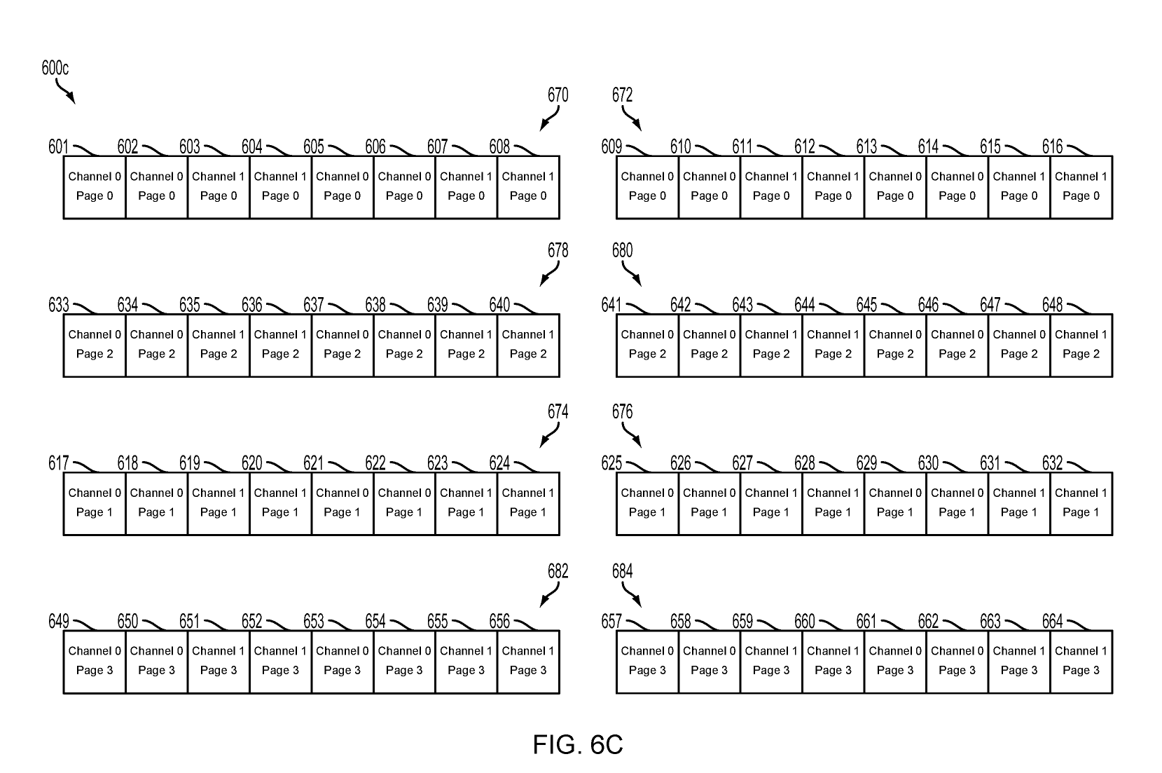

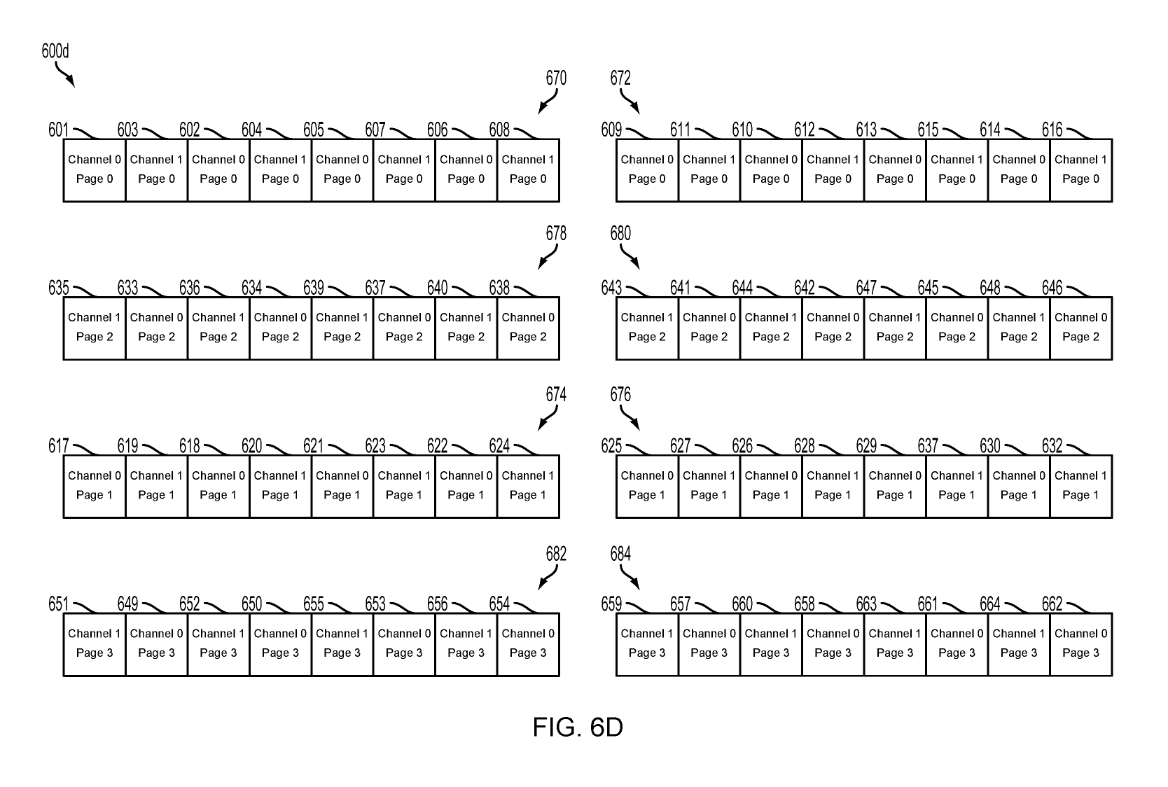

FIGS. 6A-6D illustrate examples of work item access of a memory device for execution of the work item for implementing various aspects. As described, different reverse tiling functions for assigning work item IDs to work items may result in different patterns of use of the memory device resources (e.g., memory bank 302, 304, channel 308, 310, and buffer page 312, 314, 316, 318 in FIG. 3). The examples in FIGS. 6A-6D illustrate different patterns of use of the memory device resources resulting from different reverse tiling functions. The work items may be organized by waves 601-664 having multiple work items. The waves may be organized by work groups 670-684 having multiple waves 601-664. Work items of a wave 601-664 may use the same memory device resources. Waves 601-664 of a work group 670-684 may use the same buffer pages, but may use the same or different channels or memory banks. In the various examples, the terms channel and memory bank may be used interchangeably.

The work items may be executed in parallel, and how many work items may be executed in parallel may depend on the capabilities of the processors (e.g., processors 14 in FIGS. 1 and 2) of the computing device (e.g., computing device 10 in FIG. 1). The examples in FIGS. 6A-6D illustrate parallel execution of four work items by a quad-core processor. FIGS. 6A-6D illustrate examples that are not intended to limit the description or the scope of the claims, particularly with respect to patterns of use of the memory device resources and the numbers and combinations of work items, waves, work groups, memory banks, channels, buffer pages, and parallel executions of work items.

The example in FIG. 6A illustrates a default pattern 600a of use of the memory device resources resulting from parallel sequential execution of work items based on associated work item IDs that are not subject to a reverse tiling function. In other words, the work item IDs are assigned to the work items in the order in which the work items are created. The result of the parallel sequential execution of work items may be that the work items of the waves 601-608 in the work group 670 and the executed in parallel with the work items of the waves 609-616 in the work group 672 all access a same buffer page (page 0). Similarly, the work items of the waves 617-624 in the work group 674 when executed in parallel work items of the waves 625-632 in the work group 676 all access a same buffer page (page 1). Further, the work items of the waves 601-608, 609-616 may alternate access of the channels. How frequently the access of the channels alternates may be dependent on the kernel load size.

In the example illustrated in FIG. 6A, work items of two waves 601-608, 609-616, 617-624, 625-632 of a work group 670, 672, 674, 676 may execute before alternating channels to execute further work items. However, work items of waves 601-608, 609-616, 617-624, 625-632 executing in parallel may access the same channel. For example, work items of waves 601, 602, 605, 606, work items of waves 609, 610, 613, 614, work items of wave 617, 618, 621, 622, and work items of waves 625, 626, 629, 630 may execute accessing the same channel (channel 0), and work items of waves 603, 604, 607, 608 work items of waves 611, 612, 615, 616, work items of wave 619, 620, 623, 624, and work items of waves 627, 628, 631, 632 may execute accessing the same channel (channel 1). Similar patterns of use of the memory device resources, buffer pages, page 3 and page 4, and channels, channel 0 and channel 1, also may apply to the waves 633-640 of the work group 678, the waves 641-648 of the work group 680, the waves 649-659 of the work group 682, and the waves 657-664 of the work group 684.

FIG. 6B illustrates an example of a channel balancing pattern 600b of use of the memory device resources resulting from parallel sequential execution of work items based on associated work item IDs subject to a reverse tiling function. In various aspects, the reverse tiling function may be configured to change a frequency with which the work items of the waves 601-664 alternate between accessing the channels of the memory device. The reverse tiling function may also be configured to stagger the accesses of the channels for the beginning of work groups 670-684 executing in parallel. The result of the parallel sequential execution of work items with respect to accessing of buffer pages may be the same as in the example illustrated in FIG. 6A, in which the work item IDs are not subject to a reverse tiling function. For example, the work items of the waves 601-608 in the work group 670 and the executed in parallel with the work items of the waves 609-616 in the work group 672 all access a same buffer page (page 0). Similarly, the work items of the waves 617-624 in the work group 674 and the executed in parallel work items of the waves 625-632 in the work group 676 all access a same buffer page (page 1). Similar patterns of use of the memory device resource buffer pages, page 3 and page 4, also may apply to the waves 633-640 of the work group 678, the waves 641-648 of the work group 680, the waves 649-659 of the work group 682, and the waves 657-664 of the work group 684.

However, the example illustrated in FIG. 6B differs from the example illustrated in FIG. 6A with respect to accessing of channels. In the example in FIG. 6B, the work item IDs are assigned to the work items to more frequently alternate accessed channels for executing the associated work items, such as alternating the channels accessed for each wave 601-664 executed. To increase the rate of alternating access of the channels, the reverse tiling function may be configured to change the work item IDs so that parallel sequential execution of the work items according to the work item IDs results in execution of the work items of the waves 601, 602, 605, 606, 609, 610 613, 614, 617, 618, 621, 622, 625, 626, 629, 630, 633, 634, 637, 638, 641, 642, 645, 646, 649, 650, 653, 654, 657, 658, 661, 662 having memory function addresses indicating access to a specific channel (channel 0) alternating with work items of the waves 603, 604, 607, 608, 611, 612 615, 616, 619, 620, 623, 624, 627, 628, 631, 632, 635, 634, 639, 640, 643, 644, 647, 648, 651, 652, 655, 656, 659, 660, 663, 664 having memory function addresses indicating access to a different channel (channel 1). Further, the reverse tiling function may be configured to change the work item IDs so that the work items of each wave 601, 611, 617, 627, 635, 641, 651, 657 executing in parallel at the beginning of a respective work group 670-684 also alternate the channel accessed so that parallel execution is implemented using multiple channels in parallel.

FIG. 6C illustrates an example of a page balancing pattern 600c of use of the memory device resources resulting from parallel sequential execution of work items based on associated work item IDs subject to a reverse tiling function. In various aspects, the reverse tiling function may be configured to change the order in which the work items of the waves 601-664 access the buffer pages of the memory device. The reverse tiling function may also be configured to stagger the accesses of the buffer pages for the beginning of work groups 670-684 executing in parallel. The result of the parallel sequential execution of work items with respect to accessing of channels may be similar as in the example illustrated in FIG. 6A, in which the work item IDs are not subject to a reverse tiling function. For example, work items of two waves 601-608, 609-616, 617-624, 625-632 of a work group 670, 672, 674, 676 may execute before alternating channels to execute further work items. However, work items of waves 601-608, 617-624, 633-640, 649-656 executing in parallel may access the same channel. For example, work items of waves 601, 602, 605, 606, work items of waves 617, 618, 621, 622, work items of waves 633, 634, 637, 638 and work items of waves 649, 650, 653, 654 may execute accessing the same channel (channel 0), and work items of waves 603, 604, 607, 608, work items of wave 619, 620, 623, 624, work items of waves 635, 636, 639, 640, and work items of waves 651, 652, 655, 656 may execute accessing the same channel (channel 1). Similar patterns of use of the memory device resource channels, channel 0 and channel 1, also may apply to the waves 609-616 of the work group 672, the waves 625-632 of the work group 676, the waves 641-648 of the work group 680, and the waves 657-664 of the work group 684.

However, the example illustrated in FIG. 6C differs from the example illustrated in FIG. 6A with respect to accessing of buffer pages. In the example in FIG. 6C, the work item IDs are assigned to the work items to make fewer accesses of a buffer page in parallel for executing the associated work items, such as the buffer pages accessed for each wave 601-664 executed in parallel, or to access buffer pages in series rather than in parallel. To decrease the parallel accesses of a buffer page, the reverse tiling function may be configured to change the work item IDs so that parallel sequential execution of the work items according to the work item IDs results in execution of the work items of the waves 601-608 of the of the work group 670, the work items of the waves 633-640 of the of the work group 678, the work items of the waves 617-624 of the of the work group 674, and the work items of the waves 649-656 of the of the work group 682 having memory function addresses indicating access to different specific buffer pages (e.g., the work items of the work group 670 accessing buffer page 0, the work items of the work group 678 accessing buffer page 3, the work items of the work group 674 accessing buffer page 1, and the work items of the work group 682 accessing buffer page 3). Similar patterns of use of the memory device resource page buffers, page 0, page 1, page 2, and page 3, also may apply to the waves 609-616 of the work group 672, the waves 625-632 of the work group 676, the waves 641-648 of the work group 680, and the waves 657-664 of the work group 684.

FIG. 6D illustrates an example of a channel and page balancing pattern 600d of use of the memory device resources resulting from parallel sequential execution of work items based on associated work item IDs subject to a reverse tiling function. In various aspects, the reverse tiling function may be configured to change the frequency with which the work items of the waves 601-664 alternate between accessing the channels of the memory device. The reverse tiling function may also be configured to change the order in which the work items of the waves 601-664 access the buffer pages of the memory device. The reverse tiling function may also be configured to stagger the accesses of the channels and the buffer pages for the beginning of work groups 670-684 executing in parallel. In the example in FIG. 6D, the work item IDs are assigned to the work items to more frequently alternate accessed channels for executing the associated work items, such as alternating the channels accessed for each wave 601-664 executed. To increase the rate of alternating access of the channels, the reverse tiling function may be configured to change the work item IDs so that parallel sequential execution of the work items according to the work item IDs results in execution of the work items of the waves 601, 602, 605, 606, 609, 610 613, 614, 617, 618, 621, 622, 625, 626, 629, 630, 633, 634, 637, 638, 641, 642, 645, 646, 649, 650, 653, 654, 657, 658, 661, 662 having memory function addresses indicating access to a specific channel (channel 0) alternating with work items of the waves 603, 604, 607, 608, 611, 612 615, 616, 619, 620, 623, 624, 627, 628, 631, 632, 635, 634, 639, 640, 643, 644, 647, 648, 651, 652, 655, 656, 659, 660, 663, 664 having memory function addresses indicating access to a different channel (channel 1). Further, the reverse tiling function may be configured to change the work item IDs so that the work items of each wave 601, 611, 617, 627, 635, 641, 651, 657 executing in parallel at the beginning of a respective work group 670-684 also alternate the channel accessed so that parallel execution is implemented using multiple channels in parallel.

Also in the example in FIG. 6D, the work item IDs are assigned to the work items to make fewer accesses of a buffer page in parallel for executing the associated work items, such as the buffer pages accessed for each wave 601-664 executed in parallel, or to access buffer pages in series rather than in parallel. To decrease the parallel accesses of a buffer page, the reverse tiling function may be configured to change the work item IDs so that parallel sequential execution of the work items according to the work item IDs results in execution of the work items of the waves 601-608 of the of the work group 670, the work items of the waves 633-640 of the of the work group 678, the work items of the waves 617-624 of the of the work group 674, and the work items of the waves 649-656 of the of the work group 682 having memory function addresses indicating access to different specific buffer pages (e.g., the work items of the work group 670 accessing buffer page 0, the work items of the work group 678 accessing buffer page 2, the work items of the work group 674 accessing buffer page 1, and the work items of the work group 682 accessing buffer page 3). Similar patterns of use of the memory device resource page buffers, page 0, page 1, page 2, and page 3, also may apply to the waves 609-616 of the work group 672, the waves 625-632 of the work group 676, the waves 641-648 of the work group 680, and the waves 657-664 of the work group 684.

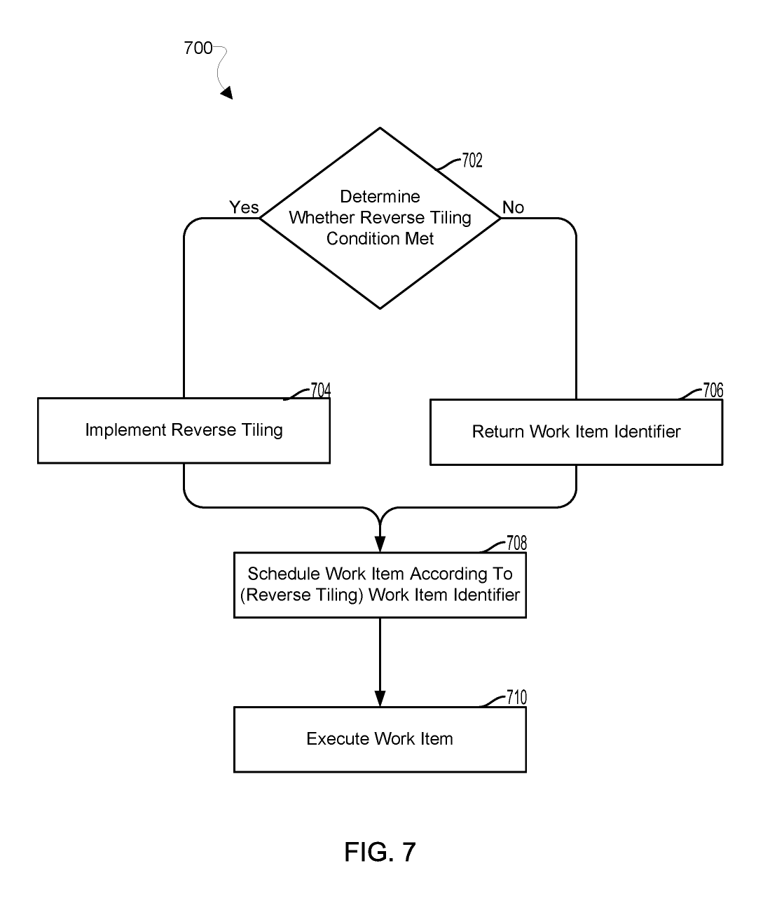

FIG. 7 illustrates a method 700 for implementing reverse tiling according to some aspects. The method 700 may be implemented in a computing device in software executing in a processor (e.g., the processor 14 in FIGS. 1 and 2), in general purpose hardware, in dedicated hardware (e.g., reverse tiling component 400, kernel parameter analysis component 402, reverse tiling function component 404, and work item ID numbering component 406 in FIG. 4), or in a combination of a software-configured processor and dedicated hardware, such as a processor executing software (e.g., reverse tiling component 400, kernel parameter analysis component 402, reverse tiling function component 404, and work item ID numbering component 406 in FIG. 4) within a computing device (e.g., computing device 10 in FIG. 1) that includes other individual components (e.g., memory 16, 24 in FIG. 1, private cache 210, 212, 214, 216, and shared cache 230 in FIG. 2, memory device 300, memory bank 302, 304, buffer page 312, 314, 316, 318, channel 308, 310, and memory device controller 306 in FIG. 3). In order to encompass the alternative configurations enabled in various aspects, the hardware implementing the method 700 is referred to herein as a “processing device.”

In determination block 702, the processing device may determine whether a reverse tiling condition is met. In various aspects, the processing device may or may not implement reverse tiling for a kernel execution. The processing device may determine whether the computing device has sufficient resources to implement reverse tiling for the kernel execution. For example, the processing device may determine whether invalid work item IDs may be created, or other restrictions may be violated. For example, work item IDs may not be assigned so that they express work item IDs that are outside of a range, such as a range of work item IDs for a work group of the work item for which a work item ID may be assigned. Such problems may occur if the number of work items is not a high enough multiple of a power of two. If the application of the reverse tiling function for assigning work item IDs to work items is viewed in terms of a highest bit changed, then 2̂(bit number) must be less than or equal to the size of the restriction. If, however, the bits are valid for most work item IDs then the reverse tiling can be used up until the point where the transformation would become invalid. The following pseudo code provides an example implementation for determining whether a reverse tiling condition is met:

If ( x < (LAST_WORKITEM_ID & (0xFFFFFFFFF <<
(TARGET_BIT+1)))

return f(x)
else return x,

where x is the value of a work item ID and f(x) is the reverse tiling function applied to the x value of a work item ID. This condition may allow reverse tiling to work for more than half of the kernel execution. In various ascents, determining whether a reverse tiling condition is met in determination block 702 may be implemented per work item or for larger execution groups, such as groups of work items, waves, kernels, etc.

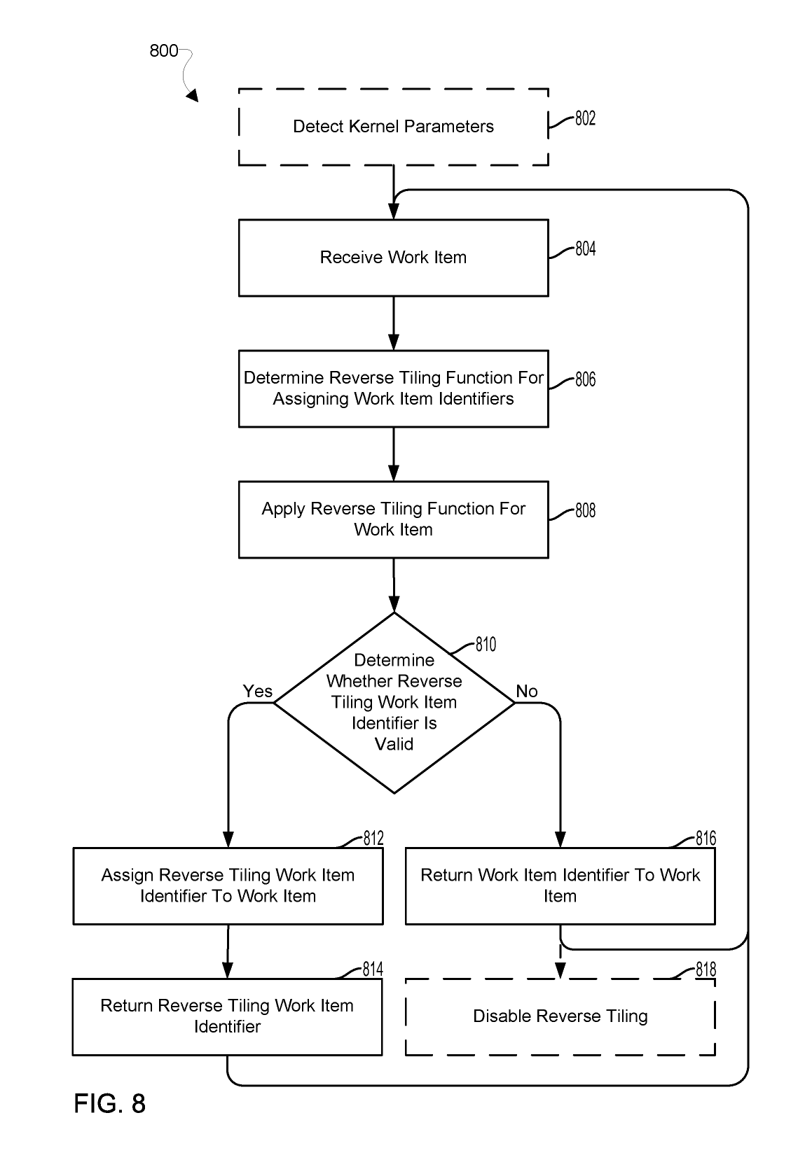

In response to deterring that the reverse tiling condition is met (i.e., determination block 702=“Yes”), the processing device may implement reverse tiling in block 704 as discussed further herein with reference to the method 800 illustrated in FIG. 8.

In response to determining that the reverse tiling condition is not met (i.e., determination block 702=“No”), the processing device may not implement reverse tiling and return the work item ID of the work item in block 706. In various aspects, not implementing reverse tiling may include assigning a work item ID to a work item when the work item is not previously assigned a work item ID. In such instances, the work item ID assigned to the work item may be a next sequential work item ID based on a work item ID previously assigned to an earlier created work item. In various aspects, not implementing reverse tiling may include not modifying a work item ID previously assigned to the work item.

Following implementing reverse tiling in block 704 and/or returning the work item ID of the work item in block 706, the processing device may schedule the work item according to the work item ID of the work item in block 708. In various aspects, scheduling the work item according to the work item ID of the work item in block 708 may be implemented in similar manners for either the work item ID for the work item resulting from reverse tiling being implemented or the work item ID for the work item resulting from no implementation of reverse tiling. The work item may be scheduled according to various scheduling schemes, including parallel sequential execution of work items according to their work item IDs. A parallel sequential execution may schedule execution of work items to multiple processing devices for execution in parallel so that sequential work item IDs are assigned for execution across the multiple processing devices. The highest and/or lowest work item ID scheduled for execution in parallel may be preceded and/or followed by a sequential work item ID for execution in parallel with another group of sequential work item IDs.

In block 710, the processing device may execute the work item as scheduled. Executing the work item may include using the memory function address of the work item to determine which memory device resources, including a channel and/or a buffer page of the memory device, to access for execution of the work item. The memory device resources indicated by the memory function address of the work item may indicate locations in the memory device storing code and/or data for executing the work item. Executing the work item may include using any number of multiple memory function addresses of the work item.

FIG. 8 illustrates a method 800 for implementing reverse tiling according to some aspects. The method 800 may be implemented in a computing device in software executing in a processor (e.g., the processor 14 in FIGS. 1 and 2), in general purpose hardware, in dedicated hardware (e.g., reverse tiling component 400, kernel parameter analysis component 402, reverse tiling function component 404, and work item ID numbering component 406 in FIG. 4), or in a combination of a software-configured processor and dedicated hardware, such as a processor executing software (e.g., reverse tiling component 400, kernel parameter analysis component 402, reverse tiling function component 404, and work item ID numbering component 406 in FIG. 4) within a computing device (e.g., computing device 10 in FIG. 1) that includes other individual components (e.g., memory 16, 24 in FIG. 1, private cache 210, 212, 214, 216, and shared cache 230 in FIG. 2, memory device 300, memory bank 302, 304, buffer page 312, 314, 316, 318, channel 308, 310, and memory device controller 306 in FIG. 3). In order to encompass the alternative configurations enabled in various aspects, the hardware implementing the method 800 is referred to herein as a “processing device.” In various aspects, the method 800 may further describe aspects of block 704 of the method 700 in FIG. 7.

In optional block 802, the processing device may detect kernel parameters for an execution of a kernel. The kernel parameters may include an identification of the executing kernel of which a work item is a unit for execution of the kernel and/or a kernel load size for the kernel. The operation of detecting kernel parameters for an execution of a kernel in block 802 may be optional because for implementations of reverse tiling with a static reverse tiling function for assigning work item IDs to work items, the kernel parameters may not be needed to make determination with regard to which reverse tiling function to use or how to configured the reverse tiling function.

In block 804, the processing device may receive a work item. In various aspects, receiving the work item may include receiving an indication of creation of a work item and/or information relating to the work item, such as a memory function address of the work item indicating memory device resources for use in executing the work item. The information relating to the work item may include a work item ID for the work item. In various aspects, the work item may be generated from a range of to-be-created work items or work item IDs.

In block 806, the processing device may determine a reverse tiling function for assigning work item IDs to work items. In various aspects the processing device may selected from preprogrammed reverse tiling functions based on prior analysis of common kernel executions of a computing device. The reverse tiling function may be configured to provide certain benefits based on the common kernel executions, and may have varying levels of effectiveness for kernels that differ in kernel load size from the common kernel executions. The reverse tiling function may be selected or configured to provide certain benefits based on the kernel parameters for a kernel executed by the computing device. The processing device may determine whether applying a reverse tiling function resulting in certain patterns of use of the memory device resources may be beneficial over a default pattern of use of the memory device resources and/or other certain patterns of use of the memory device resources. The processing device may select a pattern of use of the memory device resources for the kernel that may provide a certain benefit and/or certain combination of benefits, which may be preprogrammed for the specific kernel and/or may be general benefits for execution of kernels on the computing device. Using the information of the selected pattern of use of the memory device resources and/or the information relating to the work item, such as information of a memory function address, the processing device may select and/or generate a reverse tiling function for assigning work item IDs to work items to implement the selected pattern of use of the memory device resources.

In block 808, the processing device may apply the reverse tiling function for the work item. In various aspects, applying the reverse tiling function for the work item may include generating a work item ID for the work item that does not already have an assigned work item. In various aspects, applying the reverse tiling function for the work item may include modifying an existing work item ID for the work item. As discussed herein, the reverse tiling function may include any logical and/or arithmetic operations for manipulating bits to produce a resulting reverse tiling work item ID for the work item.

In determination block 810, the processing device may determine whether the reverse tiling work item ID for the work item is valid. As noted with reference to block 702 of the method 700 in FIG. 7, reverse tiling may be implemented even when not all of the reverse tiling work item IDs may be valid. It may be sufficient that a threshold amount of reverse tiling work item IDs may be valid when implementing reverse tiling. In various aspects, the reverse tiling work item ID may be invalid when the ID falls outside a range of valid work item IDs, such as for a work group containing the work item. The processing device may compare the reverse tiling work item ID to the range of valid work item IDs to determine whether the reverse tiling work item ID falls within the range and is therefore valid.

In response to determining that the reverse tiling work item ID is valid (i.e., determination block 810=“Yes”), the processing device may assign the reverse tiling work item ID to the work item in block 812. In various aspects, assigning a reverse tiling work item ID may include storing the reverse tiling work item ID in a location of a memory device, such as a register and/or a queue, a data structure and/or database in a memory, which may relate the reverse tiling work item ID with the work item.

In block 814, the processing device may return the reverse tiling work item ID. In various aspects, the processing device may return the reverse tiling work item ID to a scheduler and/or another processing device configured to execute the work item in an order based on the reverse tiling work item ID relative to work item IDs and/or reverse tiling work item IDs of other work items.

In response to determining that the reverse tiling work item ID is invalid (i.e., determination block 810=“No”), the processing device may return the work item ID for the work item. In various aspects, for a work item previously assigned a work item ID, the processing device may return the work item ID without modifying the work item ID in block 816. In various aspects, for a work item not previously assigned a work item ID, the processing device may assign a work item ID to the work item as a sequential work item ID based on an assigned work item ID and/or reverse tiling work item ID assigned to a previous work item. In various aspects, the processing device may return the work item ID to a scheduler and/or another processing device configured to execute the work item in an order based on the work item ID relative to work item IDs and/or reverse tiling work item IDs of other work items.

In optional block 818, the processing device may disable reverse tiling for the remainder of the kernel execution or a subset of work items, such as just for a remainder of a current work group. An invalid reverse tiling work item ID may trigger termination of reverse tiling for a kernel or a subset of work items execution because this condition may indicate that the reverse tiling work item IDs have approached and/or reached a limit of the valid reverse tiling work item IDs for the kernel or the subset of work items execution. In various aspects, the reverse tiling work item IDs may not be assigned in sequential order. Therefore it may be premature to determine that there are no remaining valid reverse tiling work item IDs, and a threshold number of invalid reverse tiling work item IDs may be required before disabling reverse tiling for the remainder of the kernel or the subset of work items execution in optional block 818.

Following returning the reverse tiling work item ID in block 814 and/or returning the work item ID in block 816, the processing device may receive another work item in block 804.

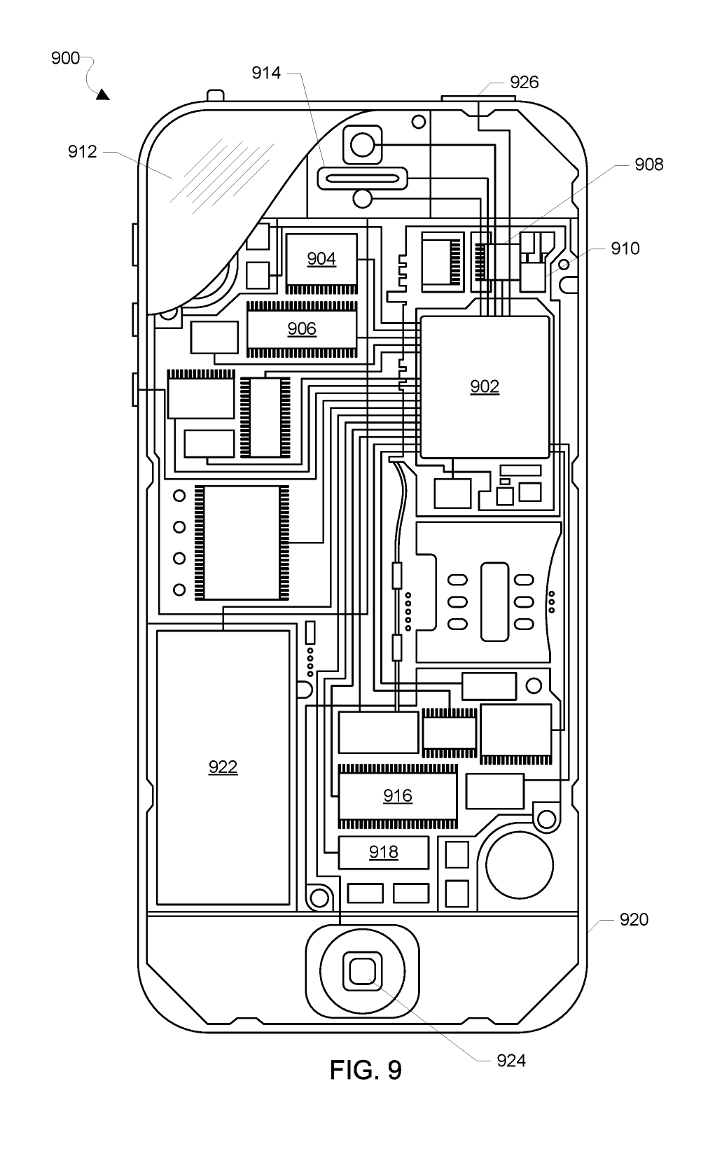

The various aspects (including, but not limited to, aspects described above with reference to FIGS. 1-8) may be implemented in a wide variety of computing systems including mobile computing devices, an example of which suitable for use with the various aspects is illustrated in FIG. 9. The mobile computing device 900 may include a processor 902 coupled to a touchscreen controller 904 and an internal memory 906. The processor 902 may be one or more multicore integrated circuits designated for general or specific processing tasks. The internal memory 906 may be volatile or non-volatile memory, and may also be secure and/or encrypted memory, or unsecure and/or unencrypted memory, or any combination thereof. Examples of memory types that can be leveraged include but are not limited to DDR, LPDDR, GDDR, WIDEIO, RAM, SRAM, DRAM, P-RAM, R-RAM, M-RAM, STT-RAM, and embedded DRAM. The touchscreen controller 904 and the processor 902 may also be coupled to a touchscreen panel 912, such as a resistive-sensing touchscreen, capacitive-sensing touchscreen, infrared sensing touchscreen, etc. Additionally, the display of the computing device 900 need not have touch screen capability.

The mobile computing device 900 may have one or more radio signal transceivers 908 (e.g., Peanut, Bluetooth, ZigBee, Wi-Fi, RF radio) and antennae 910, for sending and receiving communications, coupled to each other and/or to the processor 902. The transceivers 908 and antennae 910 may be used with the above-mentioned circuitry to implement the various wireless transmission protocol stacks and interfaces. The mobile computing device 900 may include a cellular network wireless modem chip 916 that enables communication via a cellular network and is coupled to the processor.

The mobile computing device 900 may include a peripheral device connection interface 918 coupled to the processor 902. The peripheral device connection interface 918 may be singularly configured to accept one type of connection, or may be configured to accept various types of physical and communication connections, common or proprietary, such as Universal Serial Bus (USB), FireWire, Thunderbolt, or PCIe. The peripheral device connection interface 918 may also be coupled to a similarly configured peripheral device connection port (not shown).

The mobile computing device 900 may also include speakers 914 for providing audio outputs. The mobile computing device 900 may also include a housing 920, constructed of a plastic, metal, or a combination of materials, for containing all or some of the components described herein. The mobile computing device 900 may include a power source 922 coupled to the processor 902, such as a disposable or rechargeable battery. The rechargeable battery may also be coupled to the peripheral device connection port to receive a charging current from a source external to the mobile computing device 900. The mobile computing device 900 may also include a physical button 924 for receiving user inputs. The mobile computing device 900 may also include a power button 926 for turning the mobile computing device 900 on and off.

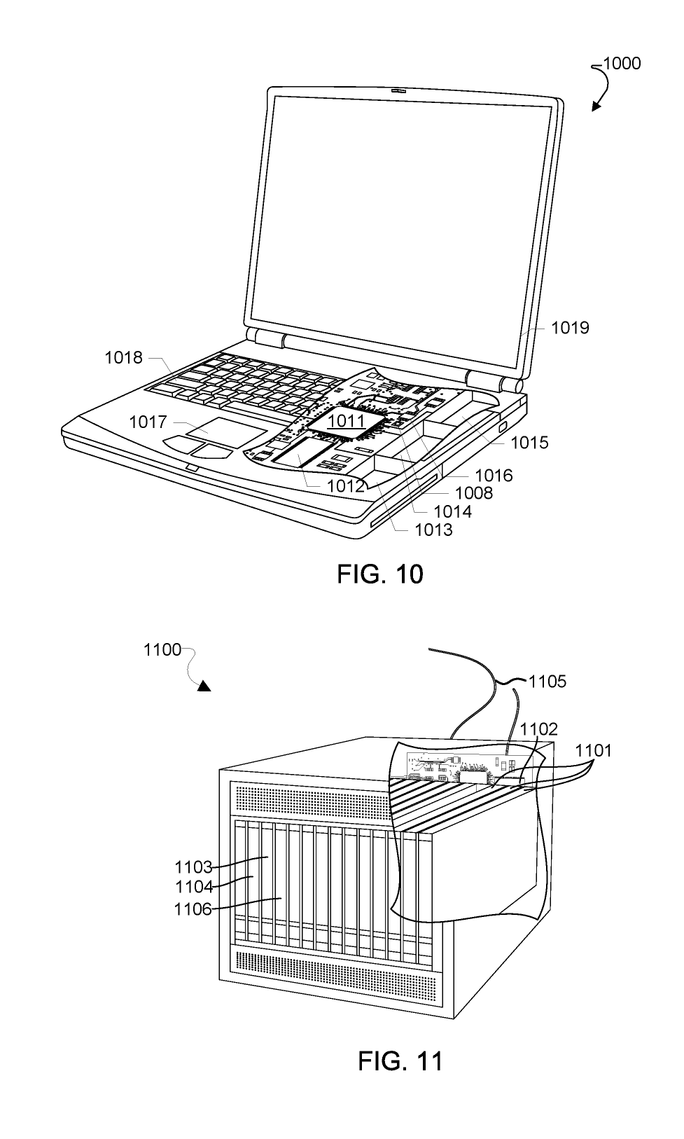

The various aspects (including, but not limited to, aspects described above with reference to FIGS. 1-8) may be implemented in a wide variety of computing systems include a laptop computer 1000 an example of which is illustrated in FIG. 10. Many laptop computers include a touchpad touch surface 1017 that serves as the computer's pointing device, and thus may receive drag, scroll, and flick gestures similar to those implemented on computing devices equipped with a touch screen display and described above. A laptop computer 1000 will typically include a processor 1011 coupled to volatile memory 1012 and a large capacity nonvolatile memory, such as a disk drive 1013 of Flash memory. Additionally, the computer 1000 may have one or more antenna 1008 for sending and receiving electromagnetic radiation that may be connected to a wireless data link and/or cellular telephone transceiver 1016 coupled to the processor 1011. The computer 1000 may also include a floppy disc drive 1014 and a compact disc (CD) drive 1015 coupled to the processor 1011. In a notebook configuration, the computer housing includes the touchpad 1017, the keyboard 1018, and the display 1019 all coupled to the processor 1011. Other configurations of the computing device may include a computer mouse or trackball coupled to the processor (e.g., via a USB input) as are well known, which may also be used in conjunction with the various aspects.

The various aspects (including, but not limited to, aspects described above with reference to FIGS. 1-8) may also be implemented in fixed computing systems, such as any of a variety of commercially available servers. An example server 1100 is illustrated in FIG. 11. Such a server 1100 typically includes one or more multicore processor assemblies 1101 coupled to volatile memory 1102 and a large capacity nonvolatile memory, such as a disk drive 1104. As illustrated in FIG. 11, multicore processor assemblies 1101 may be added to the server 1100 by inserting them into the racks of the assembly. The server 1100 may also include a floppy disc drive, compact disc (CD) or digital versatile disc (DVD) disc drive 1106 coupled to the processor 1101. The server 1100 may also include network access ports 1103 coupled to the multicore processor assemblies 1101 for establishing network interface connections with a network 1105, such as a local area network coupled to other broadcast system computers and servers, the Internet, the public switched telephone network, and/or a cellular data network (e.g., CDMA, TDMA, GSM, PCS, 3G, 4G, LTE, or any other type of cellular data network).

Computer program code or “program code” for execution on a programmable processor for carrying out operations of the various aspects may be written in a high level programming language such as C, C++, C#, Smalltalk, Java, JavaScript, Visual Basic, a Structured Query Language (e.g., Transact-SQL), Perl, or in various other programming languages. Program code or programs stored on a computer readable storage medium as used in this application may refer to machine language code (such as object code) whose format is understandable by a processor.

The foregoing method descriptions and the process flow diagrams are provided merely as illustrative examples and are not intended to require or imply that the operations of the various aspects must be performed in the order presented. As will be appreciated by one of skill in the art the order of operations in the foregoing aspects may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the various aspects may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the aspects disclosed herein may be implemented or performed with a general purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions or code on a non-transitory computer-readable medium or a non-transitory processor-readable medium. The operations of a method or algorithm disclosed herein may be embodied in a processor-executable software module that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed aspects is provided to enable any person skilled in the art to make or use the claims. Various modifications to these aspects will be readily apparent to those skilled in the art, and the generic principles defined herein may be applied to other aspects and implementations without departing from the scope of the claims. Thus, the present disclosure is not intended to be limited to the aspects and implementations described herein, but is to be accorded the widest scope consistent with the following claims and the principles and novel features disclosed herein.

What is claimed is:

1. A method of reverse tiling of work items on a computing device, comprising:
receiving information relating to a work item created for a kernel execution; and
applying a reverse tiling function to produce a reverse tiling work item identifier (ID) for the work item to implement a pattern of access of memory device resources.

2. The method of claim 1, further comprising:
receiving information relating to the kernel execution;
generating the reverse tiling function based on the information relating to the kernel execution and the pattern of access of the memory device resources.

3. The method of claim 1, further comprising:
receiving information relating to the kernel execution;
selecting the reverse tiling function from a plurality of preprogrammed reverse tiling functions based on the information relating to the kernel execution and the pattern of access of the memory device resources.

4. The method of claim 1, wherein:
receiving information relating to a work item created for the kernel execution comprises receiving a work item ID for the work item; and
applying a reverse tiling function to produce a reverse tiling work item ID for the work item comprises modifying the work item ID.

5. The method of claim 1, wherein applying a reverse tiling function to produce a reverse tiling work item ID for the work item comprises generating a work item ID for the work item as the reverse tiling work item ID.

6. The method of claim 1, further comprising:
staggering access to a memory device resource at a beginning of an execution of a first work group containing the work item relative to a second work group executed in parallel to the first work group by applying the reverse tiling function to produce the reverse tiling work item ID for the work item and assigning the reverse tiling work item ID to the work item; and
executing a plurality of work items in a sequential parallel order effecting the pattern of access of the memory device resources.

7. The method of claim 1, further comprising:
determining whether the reverse tiling work item ID is valid; and
assigning the reverse tiling work item ID to the work item in response to determining that the reverse tiling work item ID is valid.

8. The method of claim 1, further comprising:
receiving information relating to the kernel execution; and
determining whether the pattern of access of memory device resources provides a benefit over a default pattern of access of the memory device resources for the kernel execution, wherein applying a reverse tiling function to produce a reverse tiling work item identifier for the work item comprise applying the reverse tiling function to produce the reverse tiling work item identifier for the work item in response to determining that the pattern of access of the memory device resources provides a benefit over the default pattern of access of the memory device resources.

9. A computing device, comprising:
a memory device having memory device resources; and
a processor configured to perform operations comprising:
receiving information relating to a work item created for a kernel execution; and
applying a reverse tiling function to produce a reverse tiling work item identifier (ID) for the work item to implement a pattern of access of memory device resources.

10. The computing device of claim 9, wherein the processor is configured to perform operations further comprising:
receiving information relating to the kernel execution;
generating the reverse tiling function based on the information relating to the kernel execution and the pattern of access of the memory device resources.

11. The computing device of claim 9, wherein the processor is configured to perform operations further comprising:
receiving information relating to the kernel execution;
selecting the reverse tiling function from a plurality of preprogrammed reverse tiling functions based on the information relating to the kernel execution and the pattern of access of the memory device resources.

12. The computing device of claim 9, wherein the processor is configured to perform operations such that:
receiving information relating to a work item created for the kernel execution comprises receiving a work item ID for the work item; and
applying a reverse tiling function to produce a reverse tiling work item ID for the work item comprises modifying the work item ID.

13. The computing device of claim 9, wherein the processor is configured to perform operations such that applying a reverse tiling function to produce a reverse tiling work item ID for the work item comprises generating a work item ID for the work item as the reverse tiling work item ID.

14. The computing device of claim 9, wherein the processor is configured to perform operations further comprising:
staggering access to a memory device resource of the memory device resources at a beginning of an execution of a first work group containing the work item relative to a second work group executed in parallel to the first work group by applying the reverse tiling function to produce the reverse tiling work item ID for the work item and assigning the reverse tiling work item ID to the work item; and
executing a plurality of work items in a sequential parallel order effecting the pattern of access of the memory device resources.

15. The computing device of claim 9, wherein the processor is configured to perform operations further comprising:
determining whether the reverse tiling work item ID is valid; and
assigning the reverse tiling work item ID to the work item in response to determining that the reverse tiling work item ID is valid.

16. The computing device of claim 9, wherein the processor is configured to perform operations further comprising:
receiving information relating to the kernel execution; and
determining whether the pattern of access of the memory device resources provides a benefit over a default pattern of access of the memory device resources for the kernel execution, wherein applying a reverse tiling function to produce a reverse tiling work item identifier for the work item comprise applying the reverse tiling function to produce the reverse tiling work item identifier for the work item in response to determining that the pattern of access of the memory device resources provides a benefit over the default pattern of access of the memory device resources.

17. A computing device, comprising:
means for receiving information relating to a work item created for a kernel execution; and
means for applying a reverse tiling function to produce a reverse tiling work item identifier (ID) for the work item to implement a pattern of access of memory device resources.

18. The computing device of claim 17, further comprising:
means for receiving information relating to the kernel execution;
means for generating the reverse tiling function based on the information relating to the kernel execution and the pattern of access of the memory device resources.

19. The computing device of claim 17, further comprising:
means for receiving information relating to the kernel execution;
means for selecting the reverse tiling function from a plurality of preprogrammed reverse tiling functions based on the information relating to the kernel execution and the pattern of access of the memory device resources.

20. The computing device of claim 17, wherein:
means for receiving information relating to a work item created for the kernel execution comprises means for receiving a work item ID for the work item; and
means for applying a reverse tiling function to produce a reverse tiling work item ID for the work item comprises means for modifying the work item ID.

21. The computing device of claim 17, wherein means for applying a reverse tiling function to produce a reverse tiling work item ID for the work item comprises means for generating a work item ID for the work item as the reverse tiling work item ID.

22. The computing device of claim 17, further comprising:
means for staggering access to a memory device resource at a beginning of an execution of a first work group containing the work item relative to a second work group executed in parallel to the first work group by applying the reverse tiling function to produce the reverse tiling work item ID for the work item and assigning the reverse tiling work item ID to the work item; and
means for executing a plurality of work items in a sequential parallel order effecting the pattern of access of the memory device resources.

23. The computing device of claim 17, further comprising:
means for receiving information relating to the kernel execution;
means for determining whether the pattern of access of memory device resources provides a benefit over a default pattern of access of the memory device resources for the kernel execution, wherein means for applying a reverse tiling function to produce a reverse tiling work item identifier for the work item comprises means for applying the reverse tiling function to produce the reverse tiling work item identifier for the work item in response to determining that the pattern of access of the memory device resources provides a benefit over the default pattern of access of the memory device resources;
means for determining whether the reverse tiling work item ID is valid; and
means for assigning the reverse tiling work item ID to the work item in response to determining that the reverse tiling work item ID is valid.

24. A non-transitory processor-readable storage medium having stored thereon processor-executable instructions configured to cause a processor of a computing device to perform operations comprising:
receiving information relating to a work item created for a kernel execution; and
applying a reverse tiling function to produce a reverse tiling work item identifier (ID) for the work item to implement a pattern of access of memory device resources.

25. The non-transitory processor-readable storage medium of claim 24, wherein the stored processor-executable instructions are configured to cause a processor of a computing device to perform operations further comprising:
receiving information relating to the kernel execution;
generating the reverse tiling function based on the information relating to the kernel execution and the pattern of access of the memory device resources.

26. The non-transitory processor-readable storage medium of claim 24, wherein the stored processor-executable instructions are configured to cause a processor of a computing device to perform operations further comprising:
receiving information relating to the kernel execution;
selecting the reverse tiling function from a plurality of preprogrammed reverse tiling functions based on the information relating to the kernel execution and the pattern of access of the memory device resources.

27. The non-transitory processor-readable storage medium of claim 24, wherein the stored processor-executable instructions are configured to cause a processor of a computing device to perform operations such that:
receiving information relating to a work item created for the kernel execution comprises receiving a work item ID for the work item; and
applying a reverse tiling function to produce a reverse tiling work item ID for the work item comprises modifying the work item ID.

28. The non-transitory processor-readable storage medium of claim 24, wherein the stored processor-executable instructions are configured to cause a processor of a computing device to perform operations such that applying a reverse tiling function to produce a reverse tiling work item ID for the work item comprises generating a work item ID for the work item as the reverse tiling work item ID.

29. The non-transitory processor-readable storage medium of claim 24, wherein the stored processor-executable instructions are configured to cause a processor of a computing device to perform operations further comprising:
staggering access to a memory device resource at a beginning of an execution of a first work group containing the work item relative to a second work group executed in parallel to the first work group by applying the reverse tiling function to produce the reverse tiling work item ID for the work item and assigning the reverse tiling work item ID to the work item; and
executing a plurality of work items in a sequential parallel order effecting the pattern of access of the memory device resources.

30. The non-transitory processor-readable storage medium of claim 24, wherein the stored processor-executable instructions are configured to cause a processor of a computing device to perform operations further comprising:
receiving information relating to the kernel execution;
determining whether the pattern of access of memory device resources provides a benefit over a default pattern of access of the memory device resources for the kernel execution, wherein applying a reverse tiling function to produce a reverse tiling work item identifier for the work item comprise applying the reverse tiling function to produce the reverse tiling work item identifier for the work item in response to determining that the pattern of access of the memory device resources provides a benefit over the default pattern of access of the memory device resources;
determining whether the reverse tiling work item ID is valid; and
assigning the reverse tiling work item ID to the work item in response to determining that the reverse tiling work item ID is valid.
